(19) United States
(12) Patent Application Publication
(10) Pub. No.: US 2026/0308962 A1
(43) Pub. Date: Oct. 8, 2026

(54) EXHIBITION CASE AND VIEWING PANEL DISPLACEMENT ASSEMBLY

(71) Applicant: 9332-1404 QUEBEC INC., Québec (CA)

(72) Inventors: Louis ST-GELAIS, Boischatel (CA); Serge-Antoine COTE, Québec (CA); Lauraine HAMEL, Québec (CA)

(21) Appl. No.: 19/481,472

(22) PCT Filed: May 3, 2024
(86) PCT No.: PCT/CA2024/050604

§ 371 Date: Nov. 4, 2025

Related U.S. Application Data
(60) Provisional application No. 63/500,108, filed on May 4, 2023.

(51) Int. Cl. E05D 15/10; A47F 3/00; E05C 19/04; E05C 19/16; E05D 15/56

(52) U.S. Cl. CPC E05D 15/1042; A47F 3/005; E05C 19/04; E05C 19/16; E05D 15/56; E05Y 2900/20

(57) ABSTRACT

The present disclosure concerns an exhibition case, comprising a viewing panel; a frame defining: a longitudinal axis and a transversal axis, a rail for displacing the viewing panel along the longitudinal axis, and a nook laterally positioned to the rail; a panel mount engaging the viewing panel and a panel guide member having a mount-receiving portion, the panel guide member displaceable transversally to the rail between a closed configuration wherein the panel mount is housed in the nook and an open configuration wherein the panel mount is in-line with the rail; and a soft locking mechanism configured for soft locking the panel mount in either one of the closed configuration or in the open configuration. A viewing panel displacement assembly is also disclosed.

### TECHNICAL FIELD

The technical field relates to exhibition cases, and more particularly to exhibition cases comprising a viewing panel slidable on a rail.

### BACKGROUND

Exhibition cases in various applications are used to showcase objects or information behind a protection barrier, which may be viewing panels generally made of reinforced glass. The exhibition cases must therefore be as visually unintrusive as possible while offering efficient protection. Most exhibition cases generally comprise self-supporting structural modules on which heavy duty mechanical systems are installed to support and/or displace viewing panels. The mechanical systems may comprise ball bearings, sliding tracks and hinges. However, mechanical systems of the kind generally occupy a significant amount of space which results in at least partially obstructing the view of the showcased objects or information. Moreover, accessing the inside of the exhibition cases is often necessary, and displacing or uninstalling the viewing panels requires specialized equipment or heavy-duty mechanical systems for displacing or removing the viewing panels. To displace viewing panels of significant weight, displacement mechanical systems must generally be accordingly voluminous.

In view of the above, there is a need for an exhibition case with a viewing panel displacement and supporting mechanism which would be able to overcome or at least minimize some of the above-discussed prior art concerns.

### BRIEF SUMMARY

It is therefore an aim of the present invention to address the above-mentioned issues.

According to a general aspect, there is provided an exhibition case, comprising: a viewing panel; a frame defining: a longitudinal axis and a transversal axis, a rail for receiving and displacing at least a portion of the viewing panel along the longitudinal axis, and a nook laterally positioned to the rail; a panel mount engaging the viewing panel; and a panel guide member having a mount-receiving portion, the panel guide member being displaceable along the transversal axis of the frame between a closed configuration wherein the panel mount is housed in the nook and an open configuration wherein the panel mount is in-line with the rail; and a soft locking mechanism configured for soft locking the panel mount in either one of the closed configuration or the open configuration.

In another aspect, the panel mount comprises one or more of: one or more rollers pivoting about the longitudinal axis, one or more rollers pivoting about the transversal axis, and one or more rollers pivoting about a vertical axis.

In another aspect, the panel guide member comprises a rear rail-shaped segment defining the mount-receiving portion. The panel guide member can further comprise a front rail-shaped segment, the front rail-shaped segment being in-line with the rail when the panel guide member is in the closed configuration. The exhibition case can comprise an additional viewing panel and an additional panel mount engaging the additional viewing panel, wherein the additional panel mount is displaceable in the front rail-shaped segment when the panel guide member is in the closed configuration.

In another aspect, the panel guide member is slideably secured to the frame in a dovetail configuration.

In another aspect, the panel guide member comprises one or more depressions and the soft locking mechanism comprises a biasing member at least partly housed in the frame and configured to engage with the one or more depressions. The biasing member can comprise a ball and spring assembly engageable with one of the one or more depressions in the open configuration and with another of the one or more depressions in the closed configuration.

In another aspect, the soft locking mechanism comprises a magnetic mechanism. The magnetic mechanism can comprise a first magnet at least partially contained in the frame and a second magnet at least partially contained in the panel guide member.

In another aspect, the exhibition case comprises a covering band covering a combined height of the frame, the panel guide member, the panel mount and the soft locking mechanism when the panel guide member is in the closed configuration.

In another aspect, the panel guide member is in a cantilever configuration in the open configuration.

In another aspect, the transversal axis is a lateral axis.

In another aspect, the panel guide member further comprises a stopper configured to abut against the frame when past the open configuration or the closed configuration along the transversal axis.

In another aspect, the frame comprises a sealing band configured to abut against the panel guide member in the closed configuration. The sealing band can be mounted to a bracket mounted to or formed integral with the frame.

In another aspect, the frame comprises rolling means for displacing the panel guide member along the transversal axis between the closed and open configurations.

In another aspect, the frame comprises two or more frame sections substantially defining a perimeter of the exhibition case.

In another aspect, the exhibition case comprises a hard locking mechanism mounted to the frame and selectively configurable in a locked configuration to prevent displacement of the panel guide member when the panel guide member is configured in the closed configuration and in an unlocked configuration wherein displacement of the panel guide member is allowed.

In another aspect, the hard locking mechanism comprises a body secured to the frame; a locking beam slideably mounted to the body and displaceable with respect to the body to configure the hard locking mechanism in the locked configuration and the unlocked configuration; and a locking pin slideably mounted to the body and engaged with the locking beam to translate simultaneously therewith, the locking pin being configurable in a pin locked configuration wherein an engagement portion of the locking pin extends outwardly of the body and abut against the panel guide member and a pin unlocked configuration wherein the displacement of the panel guide member is allowed.

In another aspect, the hard locking mechanism comprises a body secured to the frame; and a locking pin slideably mounted to the body and translatable between a pin locked configuration wherein an engagement portion of the locking pin extends outwardly of the body preventing displacement of the panel guide member and the unlocked configuration wherein the displacement of the panel guide member is allowed.

According to another general aspect, there is provided an exhibition case, comprising: a viewing panel; a frame defining a longitudinal axis and a transversal axis and comprising a top frame section and a bottom frame section, each of the top and bottom frame sections defining: a rail for receiving and displacing at least a portion of the viewing panel along the longitudinal axis, and a nook laterally positioned to the rail; upper and lower panel mounts engaging the viewing panel; and upper and lower panel guide members each having a mount-receiving portion, the upper and lower panel guide members being displaceable along the transversal axis of the frame between a closed configuration wherein each one of the upper and lower panel mounts is housed in the corresponding nook and an open configuration wherein each one of the upper and lower panel mounts is in-line with the rail; and upper and lower soft locking mechanisms configured for soft locking the corresponding one of the upper and lower panel mounts in either one of the closed configuration or the open configuration.

In another aspect, at least one of the upper and lower panel guide members comprises one or more depressions and the corresponding one of the upper and lower soft locking mechanisms comprises a biasing member at least partly housed in the corresponding one of the top and bottom frame sections and configured to engage with the one or more depressions.

In another aspect, at least one of the upper and lower soft locking mechanisms comprises a first magnet at least partially contained in the corresponding one of the top and bottom frame sections and a second magnet at least partially contained in the corresponding one of the upper and lower panel guide members.

According to another general aspect, there is provided a viewing panel displacement assembly for an exhibition case comprising a viewing panel and a frame defining a longitudinal axis and a transversal axis, the frame comprising a rail for receiving and displacing at least a portion of the viewing panel along the longitudinal axis, and a nook laterally positioned to the rail, the viewing panel displacement assembly comprising: a panel mount engageable with the viewing panel and a panel guide member having a mount-receiving portion, wherein, when in use, the panel guide member is displaceable along the transversal axis between a closed configuration wherein the panel mount is housed in the nook and an open configuration wherein the panel mount is in-line with the rail; and a soft locking mechanism configured for soft locking the panel mount in either one of the closed configuration or the open configuration.

According to another general aspect, there is provided an exhibition case, comprising: a viewing panel; a frame defining: a longitudinal axis and a transversal axis, a rail for displacing the viewing panel along the longitudinal axis, and a nook laterally positioned to the rail; a panel mount engaging the viewing panel; and a panel guide member having an inner surface and an outer surface, opposed to the inner surface, the panel guide member comprising a rear rail-shaped segment defining a mount-receiving portion and a front rail-shaped segment from the inner surface thereof, the panel guide member being displaceable along the transversal axis of the frame between: a closed configuration wherein the rear rail-shaped segment is housed in the nook and the front rail-shaped segment is in-line with the rail; and an open configuration wherein the rear rail-shaped segment is in-line with the rail and the front rail-shaped segment projects from the frame unsupported.

In another aspect, the exhibition case further comprises an additional viewing panel and an additional panel mount engaging the additional view panel, wherein the additional panel mount is displaceable in the front rail-shaped segment when the panel guide member is in the closed configuration.

### BRIEF DESCRIPTION OF THE DRAWINGS

FIG. 1 is a front perspective view of an exhibition case in accordance with an embodiment;

FIG. 2A is a front perspective view of an exhibition case in accordance with an embodiment, the exhibition case being in a closed state;

FIG. 2B is another front perspective view of the exhibition case of FIG. 2A, the exhibition case being in an unclosed state;

FIG. 3 is a front elevation view of the exhibition case of FIG. 2A;

FIG. 4 is a cross-sectional view of the exhibition case of FIG. 2A, taken along cross-section lines 4-4 of FIG. 3;

FIG. 5 is a front elevation view of the exhibition case shown in FIG. 2B, in the unclosed state;

FIG. 6 is a cross-sectional view of the exhibition case of FIG. 2B, taken along cross-section lines 6-6 of FIG. 5;

FIG. 7 is a top perspective view of a frame and a viewing panel displacement assembly including a panel mount, a panel guide member and a soft locking mechanism in accordance with an embodiment, the panel guide member and the panel mount being shown in the closed configuration in full lines and in the open configuration in dotted lines;

FIG. 8 is a top perspective view of a frame and a viewing panel displacement assembly including a panel mount, a panel guide member and a soft locking mechanism in accordance with another embodiment, the panel guide member and the panel mount being shown in the closed configuration in full lines and in the open configuration in dotted lines;

FIG. 9 is a bottom perspective view of the panel mount in accordance with the embodiment of FIG. 7;

FIG. 10 is a bottom perspective view of the panel mount in accordance with the embodiment of FIG. 8;

FIG. 11 is a top plan view of a panel guide member and a frame in accordance with an embodiment, wherein the panel guide member is in the closed configuration;

FIG. 12 is a front elevation view of the panel guide member and the frame of FIG. 11;

FIG. 13 is a top plan view of the panel guide member and the frame of FIG. 11, wherein the panel guide member is in the open configuration;

FIG. 14 is a front elevation view of the panel guide member and the frame of FIG. 13;

FIG. 15 is a cross-sectional view of the panel guide member and the frame of FIG. 12, taken along cross-section lines 15-15 of FIG. 12 (in the closed configuration), showing a soft locking mechanism in accordance with an embodiment;

FIG. 16 is a cross-sectional view of the panel guide member and the frame of FIG. 14, taken along cross-section lines 16-16 of FIG. 14 (in the open configuration), showing the soft locking mechanism of FIG. 15;

FIG. 17 is a front elevation view of a panel guide member and a frame in accordance with an embodiment, the panel guide member being in the closed configuration;

FIG. 18 is a side elevation view of the panel guide member and the frame of FIG. 17 in the closed configuration;

FIG. 19 is a front elevation view of a panel guide member and a frame in accordance with an embodiment, the panel guide member being in the open configuration;

FIG. 20 is a side elevation view of the panel guide member and the frame of FIG. 19 in the open configuration;

FIG. 21 is a cross-sectional view of the panel guide member and the frame of FIG. 17, taken along cross-section lines 21-21 of FIG. 17, showing a soft locking mechanism in accordance with an embodiment;

FIG. 22 is a cross-sectional view of the panel guide member and the frame of FIG. 19, taken along cross-section lines 22-22 of FIG. 19, showing the soft locking mechanism of FIG. 21;

FIG. 23 is a front elevation view of a portion of an exhibition case in accordance with an embodiment, in the closed state;

FIG. 24 is a cross-sectional view of the portion of the exhibition case of FIG. 23, taken along cross-section lines 24-24 of FIG. 23;

FIG. 25 is a front elevation view of the portion of the exhibition case shown in FIG. 23, in the unclosed state;

FIG. 26 is a cross-sectional view of the portion of the exhibition case of FIG. 25, taken along cross-section lines 25-25 of FIG. 25;

FIG. 27 is a top perspective view of a frame and a viewing panel displacement assembly in the closed configuration including a panel mount, a panel guide member, a soft locking mechanism, and a hard locking mechanism in accordance with an embodiment;

FIG. 28 is a top perspective view of the frame and the viewing panel displacement assembly of FIG. 27 in the open configuration;

FIG. 29 is a top perspective view of an exemplary hard locking mechanism in a locked configuration;

FIG. 30 is a top perspective view of the hard locking mechanism of FIG. 29 in an unlocked configuration;

FIG. 31 is a top plan view of the hard locking mechanism of FIG. 29, in the locked configuration;

FIG. 32 is a cross-sectional view of the hard locking mechanism of FIG. 29, in the locked configuration, taken along cross-section lines 32-32 of FIG. 31;

FIG. 33 is a top plan view of the hard locking mechanism of FIG. 30, in the unlocked configuration; and

FIG. 34 is a cross-sectional view of the hard locking mechanism of FIG. 30, in the unlocked configuration, taken along cross-section lines 34-34 of FIG. 33.

It will be noted that throughout the appended drawings, like features are identified by like reference numerals.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward” “left”, “right” and the like should, unless otherwise indicated, be taken in the context of the figures only and should not be considered limiting. In the specification, the terms “inner” and “outer” are used in the context of a viewing panel, wherein inner is proximal to the viewing panel and outer is distal from the viewing panel.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

It will be appreciated that the term “transversal”, “transversally” and the like should, unless otherwise indicated, be taken in the context of an axis or direction crossing through another axis or direction. For example, a transversal axis to a longitudinal axis would imply that the transversal axis crosses through the longitudinal axis. The crossing angle may be any angle between 0 and 180 degrees, the interval being an open interval. Specific embodiments may refer to “lateral” axis, which may be taken in the context of the axis being at 90 degrees from the axis to which it is compared to; these embodiments must however be taken only in the context of said embodiments and are not limitative for the rest of the possible embodiments. The term “laterally” may however be taken in the context of “next to” or “on the side of”, especially if it refers to the position of an element relative to another element, for example in the expression “the nook laterally positioned to the rail”. On the other hand, the term “laterally” may be taken in the context of “in the direction of the lateral axis” if it refers to the direction of a movement, for example in the expression “the panel mount laterally crossing the rail” or “the panel mount laterally displaced”.

In the following description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the above description, an embodiment is an example or implementation of the exhibition case described herein. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the exhibition case may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention.

Furthermore, it is to be understood that the invention can be carried out or practiced in various ways and that the invention can be implemented in embodiments other than the ones outlined in the description above. It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

In accordance with one aspect, the present description concerns an exhibition case. The exhibition case may be used in any type of application requiring the exhibition of objects or visual information behind a protected enclosure. The exhibition case may generally be placed against a wall, not shown, and will delimit an area or volume of space to be protected between said exhibition case and wall. In another embodiment, the exhibition case may be encased within a wall. Therefore, the exhibition case may act as a barrier between objects that are exhibited and the outside world. In a specific embodiment, the exhibition case may be used in a museum to protect and exhibit valuable objects. In further embodiments, the exhibition case may be used in any other type of exhibitions such as libraries, universities, private installations, and jewelry and commercial displays.

It is to be understood that the term “hard locking mechanism” refers to a mechanism that is selectively configurable in a locked configuration and in an unlocked configuration by selectively configuring one or more component of the mechanism in a locked configuration or in an unlocked configuration respectively. Thus, a change of configuration onto at least one component of the mechanism is required to modify the state of the hard locking mechanism, i.e. from the unlocked configuration to the locked configuration, or vice-versa. The component(s) of the hard locking mechanism has to be configured in the unlocked configuration before the object or mechanism that is hard locked by the hard locking mechanism can have its configuration modified, such as by displacement.

It is also to be understood that the term “soft locking mechanism” refers to a mechanism that prevents another object or mechanism to leave a given configuration, e.g., a closed configuration, unless an external force with a minimum value is applied on the object or mechanism that is soft locked. The minimum value can vary depending on various factors such as the direction of the applied external force, the weight of the object or mechanism to be displaced, the type of soft locking mechanism, etc.

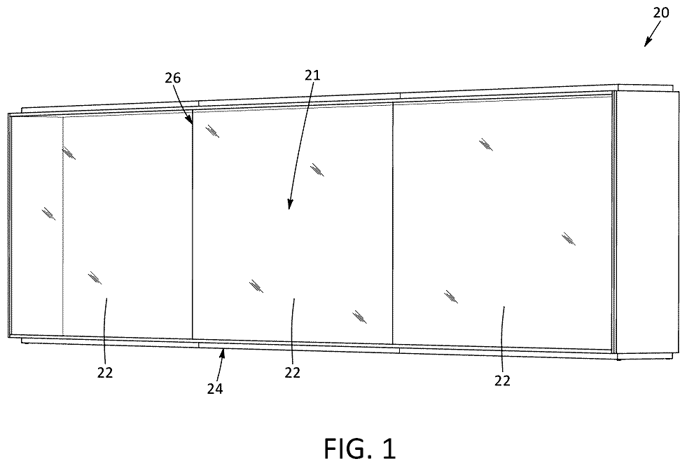

Referring now to the drawings, and more particularly to FIG. 1, an embodiment of an exhibition case 20 is shown. In the embodiment shown, the exhibition case 20 includes one or more viewing panels 22 (for instance and without being limitative, three panels, in the embodiment of FIG. 1) and a frame 24 enclosing an exhibition space 21. At least one of the viewing panels 22 may be positioned in an open or in a closed state or configuration. Depending on the state of the one or more viewing panels 22, the exhibition case 20 can therefore be in a corresponding unclosed or closed state or configuration. The unclosed state or configuration can also be referred to as open state or configuration. In the open configuration, the viewing panel 22 is slidable longitudinally to provide access to the exhibition space 21, as detailed below. In the closed configuration, the viewing panel 22 may not be displaced longitudinally and at least partially delimits the exhibition space 21. As will be detailed further below, the exhibition case 20 further includes a soft locking mechanism 26 that can soft lock the viewing panel 22 in the closed and open configurations, such that a change from the closed configuration to the open configuration and vice versa may be initiated by a force applied to the exhibition case by a user and cannot be accidentally performed. Furthermore, the soft lock ensures that the viewing panel 22 is in a precise and predetermined position in the closed or in the open configuration.

In the embodiment shown, the viewing panel 22 is configured to allow viewing of objects located inside the exhibition space 21, such as between the viewing panel 22 and any opposing wall, while simultaneously providing a physical barrier against the outside world. The viewing panel 22 may be made of glass, acrylic, plexiglass, wood, fiber-based materials, or composite materials. It may be appreciated that the viewing panel 22 may be made of material that is partly or fully transparent to allow see-through viewing. The illustrated viewing panel 22 has a substantially rectangular shape, however, in other embodiments, it may also have any other shape known in the art. The shape of the viewing panel 22 may be configured to fit within the frame 24 of the exhibition case 20. In some embodiments, the viewing panel 22 may be, for instance, 12 feet×12 feet and weigh up to 1200 pounds (545 kg). The viewing panel 22 may, in other embodiments, have other dimensions and a different weight. It will be readily understood that the exhibition case 20 may include a plurality of viewing panels 22, and that one or more of the plurality of viewing panels 22 may or may not be mounted to the frame 24 as described herein. By way of example, while the shown embodiment of FIG. 1 comprises three viewing panels 22, it is to be understood that other embodiments may comprise more or less viewing panels 22. For simplicity, the present disclosure uses the singular when referring to the viewing panel 22 without implying any limitation on the number of viewing panels 22 provided with a given exhibition case 20.

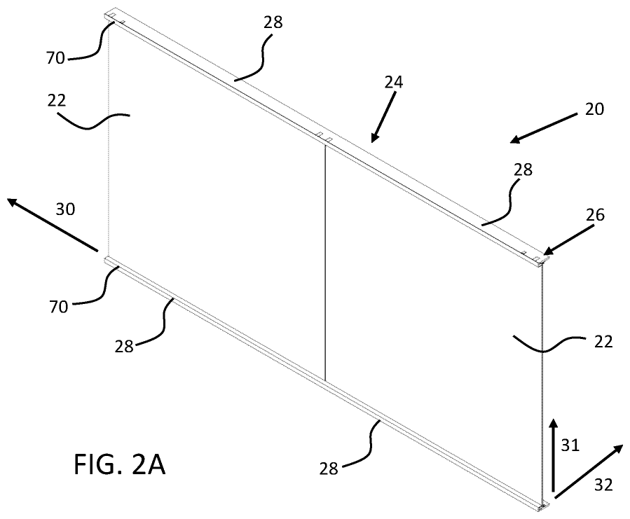

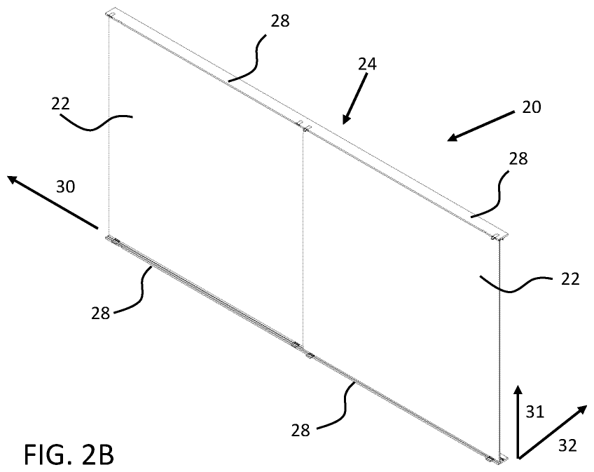

As represented in the embodiments of FIGS. 1, 2A and 2B, the shown exhibition case 20 includes the frame 24. The frame 24 provides structural integrity to the exhibition case 20 and defines the general shape of the same. Accordingly, the frame 24 generally encompasses the viewing panel 22 and the shape of one or the other will be configured according to the other. The frame 24 may be made of one or more of, without being limited to, aluminum, steel, copper, titanium, alloys thereof, polymers such as UHMW-PE, HDPE, PTFE, ABS, PVC, or a combination thereof. The frame 24 may be made of one or more sections 28 and may substantially partly or fully define the perimeter of the exhibition case 20. The frame 24 may include horizontal and vertical frame sections 28, angled frame sections 28 and upper (or top), lower (or bottom), left and right frame sections 28. The frame 24 may therefore be manufactured as a single section 28 or a plurality of sections 28. As is shown in FIGS. 2A and 2B, the frame 24 is divided in four sections 28: two top sections 28 defining the top of the frame 24 and two bottom sections 28 defining the bottom of the frame 24. In other embodiments, not shown, the frame 24 may comprise sections 28 disposed vertically at any needed angle between upper and lower frame sections 28.

The frame 24 may define a longitudinal axis 30 along its length and a corresponding transversal axis 32. In the embodiment shown, the transversal axis 32 is a lateral axis. It may however be understood that in other embodiments, the transversal axis 32 may be oriented relative the longitudinal axis 30 at angles other than perpendicular. The longitudinal axis 30 and the transversal axis 32 may be in the same horizontal plane or in different horizontal planes. In embodiments having at least an upper and a lower frame section 28, the longitudinal axis 30 of each of the sections 28 may be in the same direction than the other longitudinal axis 30, although offset within the vertical plane. In the embodiment shown, the frame 24 follows the longitudinal axis 30 along its entire length. In further embodiments, the frame 24 may substantially or at least generally follow the longitudinal axis 30 by being angled or curved along its length.

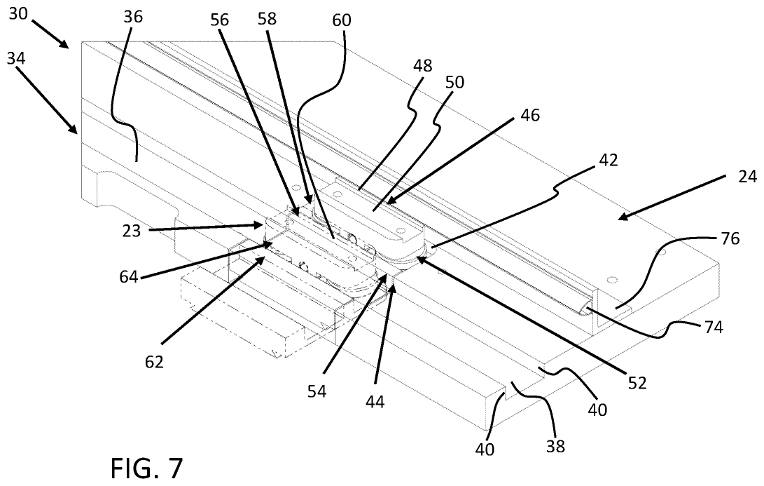

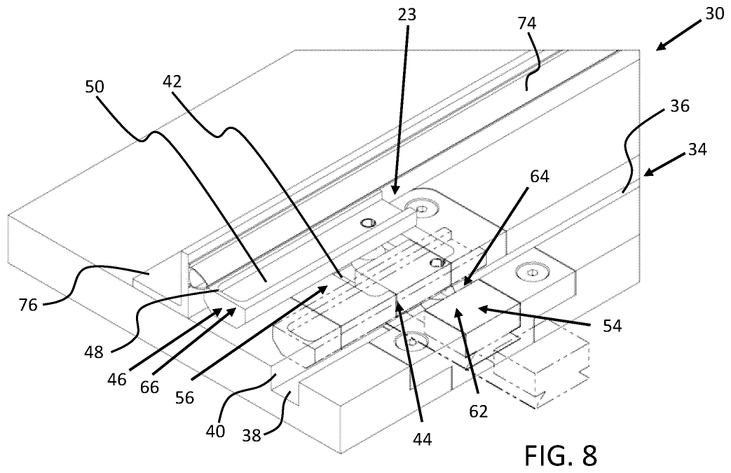

Referring to FIGS. 7 and 8, in some embodiments the frame 24 comprises a rail 34 for displacing the viewing panels 22 along the longitudinal axis 30. In an implementation, the rail 34 may include or be substantially embodied by a top-down recess 36 manufactured within the body of the frame 24. In other words, the rail may at least be partially formed integral with the frame. The recess 36 of the rail 34 may be substantially rectangular. Understandably, the recess 36 and the rail 34 may have any other shape known in the art. As best seen in FIGS. 7 and 8, the rail 34 may be embodied as a recess 36 of a substantially rectangular shape (or cross-section) with a flat bottom surface 38 and spaced-apart flat side walls 40. In other embodiments not shown, the bottom surface 38 of the recess 36 of the rail 34 may have parallel bars acting as railroads to improve guiding of the viewing panel 22 during its displacement at least along the longitudinal axis 30.

In the embodiment shown herein, the rail 34 is manufactured singularly with the body of the rest of the frame 24. In other embodiments, the rail 34 may be manufactured separately to the body of the frame 24 and may be assembled to the same by any means known in the art. In further embodiments, the rail 34 may be detachably secured to the body of the frame 24 and may therefore be removed from the same to be repaired or exchanged with another rail 34. The rail 34 may perfectly or substantially follow the longitudinal axis 30 of the frame 24. The rail 34 may thus fully or partly follow the longitudinal axis 30 of the frame 24. It may therefore be appreciated that the rail 34 may have angles or curves along its length which may or may not correspond with any possible angles or curves of the frame 24.

In further embodiments, there may be two or more rails 34. The second and any subsequent rail 34 may be adjacent to the first rail 34 or anywhere else on the frame 24. The second and subsequent rails 34 may have other orientations, size, shape, and length than the first rail 34. As an example, a second rail 34 may be angled from the first rail 34 and may provide one or more additional displacement paths to the viewing panel 22 other than a longitudinal path.

Referring still to FIGS. 7 and 8, the frame 24 may further comprise a nook 42. The nook 42 may be a recess manufactured within the body of the frame 24 and positioned laterally (i.e., offset along the lateral axis of the frame) and adjacent to the rail 34. In the embodiment shown, one of the side walls 40 of the rail 34 comprises an opening 44 from which the nook 42 is accessed. The nook 42 may have a width close to, equal, or larger than the width of the rail 34, defined between the spaced-apart flat side walls of the recess. The nook 42 may also have a height close to, equal or larger than the height of the rail's recess 36. Accordingly, an object received by the rail 34 may similarly be received by the nook 42, at least width wise and/or height wise. There may be one or more nooks 42 per frame section 28, arranged along the longitudinal axis of the frame. In the embodiment of FIG. 2B, two nooks 42 are included per frame section 28 and per viewing panel 22. In yet other embodiments, different sections of a single frame 24 may comprise different numbers of nooks 42.

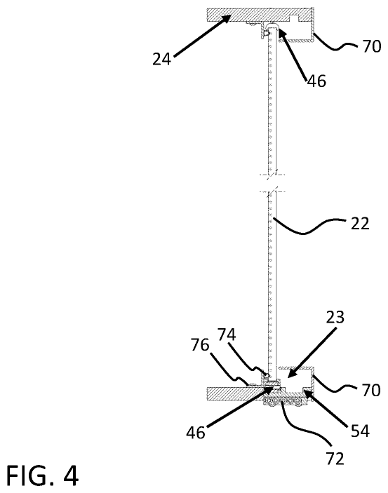

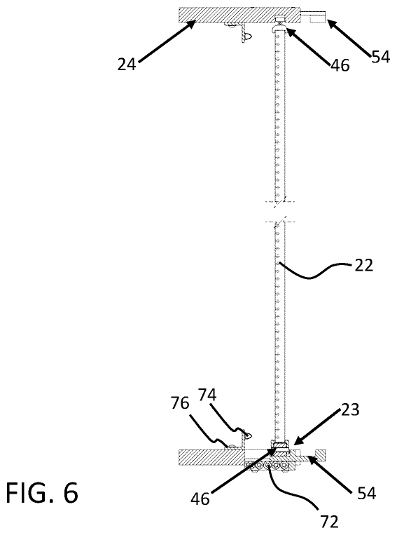

Referring back to the FIGS. 4, 7 and 8, the exhibition case 20 comprises a viewing panel assembly 23, also referred to as viewing panel displacement assembly, in which is included a panel mount 46 for engaging directly or indirectly with the viewing panel 22. The panel mount 46 is configured to receive the viewing panel 22 or any object connected to the viewing panel 22 and guide said panel 22 in the longitudinal 30 and/or transversal 32 axes. The panel mount 46 may thus have a top surface 48 with a shape corresponding to the edge of the viewing panel 22 to receive said viewing panel 22. In an exhibition case 20, there may be a plurality of panel mounts 46 included. The panel mounts 46 may be located on the bottom of the exhibition case 20 and/or on the top of the same. It may therefore be understood that any direction, such as top and bottom, when describing the panel mounts 46 may be reversed if said panel mount 46 is used elsewhere on the exhibition case 20. As an example, the panel mount 46 of FIG. 7 may be found at the bottom of the exhibition case 20 embodiments of FIGS. 4 and 6 whereas the panel mount 46 of FIG. 8 may be found at the top of the exhibition case 20 embodiments of FIGS. 4 and 6. Different embodiments of panel mounts 46 may further be located on a single frame section 28 at varying quantities for each of the embodiments of panel mounts 46.

In the embodiment of FIG. 7, the top surface 48 of the panel mount 46 has a mount-receiving portion 50. The mount-receiving portion 50 can be a substantially rectangular recess for receiving an edge of the viewing panel 22 having a corresponding substantially rectangular bottom. Alternatively, the mount-receiving portion 50 may have any other shape that can mate with the corresponding edge of the viewing panel 20. The panel mount 46 may have a shape allowing partial housing in the nook 42 and in the rail 34. It may be understood that the panel mount 46 having a shape corresponding with the shape of the viewing panel 22 may allow a snug fit of one within the other for a more secure mounting. In other embodiments not shown, the panel mount 46 may comprise additional fixation means for securing the viewing panel 22, such as but not limited to clips, brackets, suction cups, etc. In the embodiment shown, a lower portion (for instance a lower half) of the panel mount 46 is housed within the nook 42 and/or the rail 34 and an upper portion (for instance an upper half) is projecting over the same.

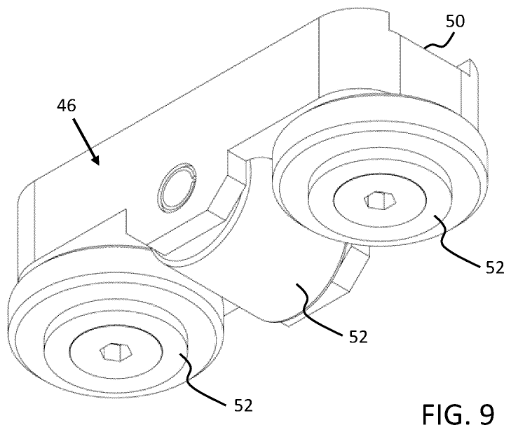

Now referring to FIGS. 7 and 9, the embodied panel mount 46 comprises rollers 52 for displacing the panel mount 46 within the frame 24. The embodiment shown comprises three rollers 52, namely two rollers 52 pivoting about a vertical axis 31 (FIG. 2A) and one roller 52 pivoting about the lateral axis 32 (FIG. 2A). There may, however, be any number of rollers 52 pivoting about the vertical 31, lateral 32 and/or longitudinal 30 axes. The rollers 52 are configured to roll against the frame 24, for example inside the rail 34, and other mounts of the exhibition case 20. The type, shape and orientation of the rollers 52 may vary in other embodiments that are not shown. For example, the rollers 52 may be embodied as wheels, balls, caterpillar tracks or a combination thereof. A single panel mount 46 may comprise different types, sizes, and shapes of rollers 52.

In another embodiment, the panel mount 46 may pivot about the vertical axis 31. Rollers 52 may be configured to enable for the panel mount 46 to pivot about the vertical axis 31. It may be appreciated that with the panel mount 46 pivoting about the vertical axis 31, the panel mount 46 may be aligned with other rails 34 having different angles than the rail 34 following the longitudinal axis 30. As such, the viewing panel 22 guided by the panel mount 46 may be pivoted to follow a path defined by a rail 34 extending at a non-void angle from the longitudinal axis 30. The viewing panels 22 being displaced on rails 34 angled from the longitudinal axis 30 may accordingly result in a larger opened area within the exhibition case 20.

Referring back to FIGS. 4 and 7, the viewing panel displacement assembly 23 further includes a panel guide member 54 for guiding the viewing panel 22 transversally to the rail 34 and thereof along the lateral axis 32 of the frame 24. In some implementations, the panel guide member 54 may include a rear rail-shaped segment 56 defining a mount-receiving portion. The rear rail-shaped segment 56 may include a top-down recess 58 from an upper surface 60 of the panel guide member 54. The recess 58 may have dimensions, at least in width and height, substantially similar or equal to the dimensions of the rail 34. Understandably, the rear rail-shaped segment 56 may have a shape similar to the shape of the rail 34. For example, the rear rail-shaped segment 56 may comprise parallel bars acting as railroads if the rail 34 comprises the same. The rail 34 and the rear rail-shaped segment 56 may therefore each have a recess 36, 58 shaped and dimensioned to receive the panel mount 46.

In the embodiment shown, the panel guide member 54 is displaceable along the lateral axis 32 between two configurations. One of the two configurations is a closed configuration (FIG. 4) and the other of the two configurations is an open configuration (FIG. 6). In the shown embodiment, the closed configuration is rearward of the exhibition case 20 and the open configuration is forward of the exhibition case 20. The term “rearward” refers to a position that is closer to the rear of the exhibition space 21, the rear being the objects that are exhibited and the walls. The term “forward” refers to a position that is closer to the front of the exhibition case 20, the front being the outside world and the people watching the exhibited objects. It may however be understood that the closed configuration and the open configuration may either be in front or in the rear of the exhibition case. Accordingly, any described position of elements from the embodiments shown may be reversed to obtain similar or equal effects.

In the closed configuration, the rear rail-shaped segment 56 may be partly or fully housed within the nook 42 of the frame 24. In the open configuration, the rear rail-shaped segment 56 may be in-line with the rail 34. In the open configuration, the recess 58 of the rear rail-shaped segment 56 corresponds with and continues the recess 36 of the rail 34 along the longitudinal direction. In the closed configuration, the panel guide member 54 may receive the panel mount 46 within the nook 42. When the panel guide member 54 is displaced in the open configuration, the panel mount 46 may be received by the panel guide member 54 that is in-line with the rail 34. It may thus be appreciated that in the open configuration, the panel mount 46 may be displaced longitudinally out of the rear rail-shaped segment 56 along the rail 34 and vice versa.

Still referring to FIG. 7, the panel guide member 54 may further comprise a front rail-shaped segment 62. The front rail-shaped segment 62 may have a recess 64 with the same or a substantially similar shape than the recess 58 of the rear rail-shaped segment 56 and thereof the rail 34. The front rail-shaped segment 62 may be located adjacent to the rear rail-shaped segment 56 and may be laterally displaced simultaneously. When the rear rail-shaped segment 56 is received by the nook 42 in the closed configuration, the front rail-shaped segment 62 may be in-line with the rail 34. When the rear rail-shaped segment 56 is in-line with the rail 34 in the open configuration, the front rail-shaped segment 62 may be in front of the rail 34 (laterally offset therewith), and project from the frame 24, unsupported or in a cantilever configuration (i.e., it extends horizontally and is supported only at one end), that is, the frame 24 has no structure meant to support the front rail-shaped segment 62 from underneath in this configuration which could be visually displeasing when the panel guide member 54 is in the closed configuration. It will be appreciated that when the panel mount 46 and the viewing panel 22 are in the closed configuration, another panel mount 46 with its associated viewing panel 22 may be displaced longitudinally in the rail 34 and the front rail-shaped segment 62. Accordingly, it may be possible to displace a panel mount 46 and an associated viewing panel 22 along the frame 24 comprising a plurality of sections 28 when other panel mounts 46 and viewing panels 22 are in the closed configuration.

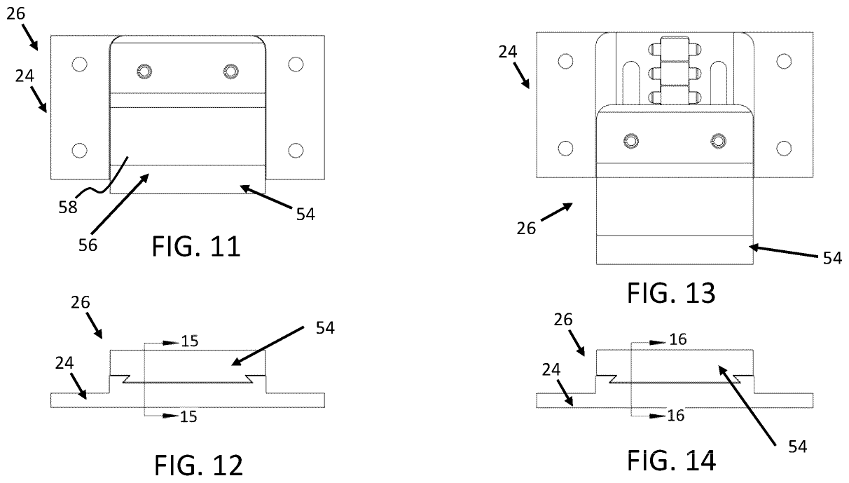

Referring now to the embodiments of FIGS. 11 to 14 and 17 to 20, the panel guide members 54 are slideably mounted to the frame 24 in a dovetail configuration. The dovetail configuration may allow sliding of the panel guide member 54 laterally within the frame 24 while limiting vertical and longitudinal displacements of the same by making sure the frame 24 and the panel guide members 54 are manufactured with a small and precise tolerance. The shape of the dovetail configuration may differ in other embodiments that are not shown.

Referring now to FIGS. 8, 10, 15, 16, 21 and 22, other embodiments of the panel mount 46 and the panel guide member 54 are shown. In the FIGS. 8, 10, 15, 16, 21 and 22, the panel guide member 54 comprises the rear rail-shaped segment 56 and the front rail-shaped segment 62. Each of the rear and front rail-shaped segments 56, 62 comprise a recess 58, 64 with a shape substantially similar to the recess 36 of the rail 34; the shape being substantially rectangular in this embodiment. Hence, in the closed configuration, the rear rail-shaped segment 56 may receive the panel mount 46 and the front rail-shaped segment 62 may be in-line with the rail 34 and thus receive another displaced (or translated) panel mount 46. In the open configuration, the rear rail-shaped segment 56 may be in-line with the rail 34 so that the panel mount 46 may be displaced in and out of the same in the rail 34 and the front rail-shaped segment 62 may project in front of the frame 24.

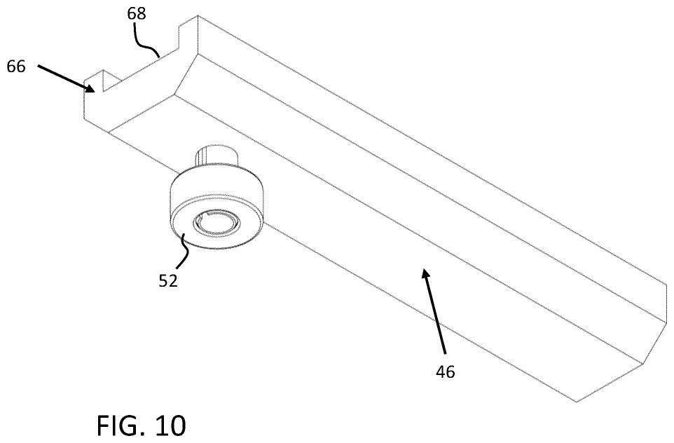

Referring now to FIGS. 8 and 10, the panel mount 46 comprises a mount receiving portion 66 and a roller 52. The mount receiving portion 66 has a recess 68 of a substantially rectangular shape to receive and guide the viewing panel 22. Understandably, the recess 68 of the mount receiving portion 66 may have any shape corresponding with the shape of the viewing panel 22. The roller 52 is embodied as a single wheel pivoting in the vertical axis 31. The roller 52 may thus facilitate displacement within the longitudinal axis 30 in the panel guide member 54 and in the rail 34.

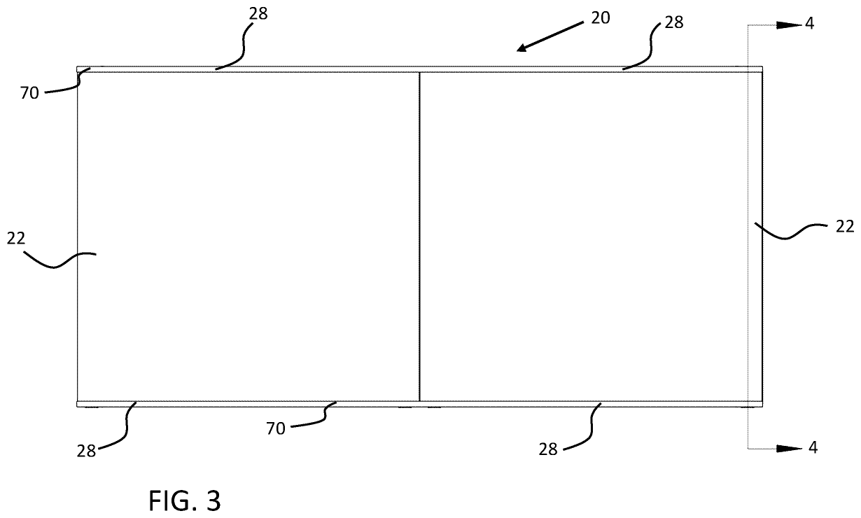

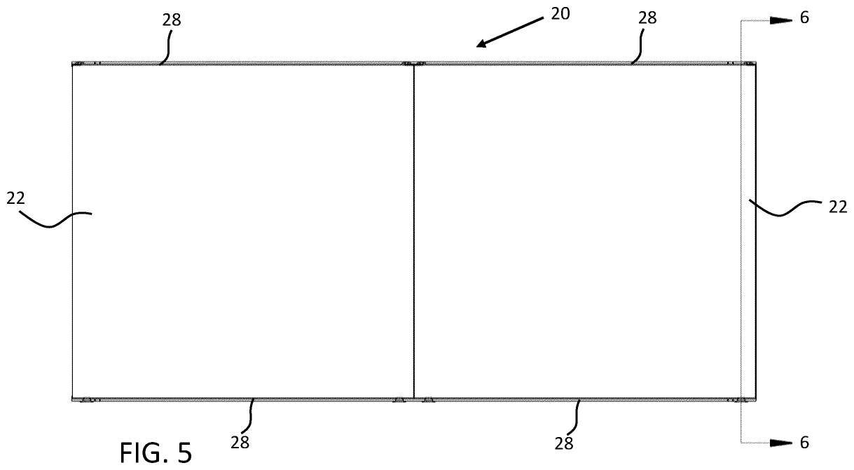

Referring back to FIGS. 2A, 2B, 3 and 5, embodiments of the exhibition case 20 are shown. There are four frame sections 28 in the embodiments as explained precedingly. For each pair of upper and lower frame sections 28, there is a viewing panel 22 which may be positioned in the open or closed configuration. If one of the two viewing panels 22 is in the closed configuration, the other of the two viewing panels 22 may be displaced in the open configuration and may be consequently displaced in front of the other viewing panels 22.

In some implementations, with balance and stability of the viewing panel 22 in mind, there may be two panel mounts 46 for each viewing panel 22. Namely, there is one panel mount 46 at or close to each of the longitudinal extremities supporting the bottom of a viewing panel 22. It may be understood that there may be more or less panel mounts 46 for a given viewing panel 22. The position and number of panel guide members 54 and nooks 42 will correspond to the position and number of panel mounts 46 for a viewing panel 22. In the shown embodiment, the location of panel mounts 46 of a viewing panel 22 of one of the frame sections 28 corresponds to the location of panel mounts 46 of the other viewing panel 22 of the other frame section 28. The panel guide members 54 and nooks 42 of the frame section 28 may therefore be used with other viewing panels 22 and panel mounts 46 if the initial viewing panel 22 and associated panel mounts 46 are removed. In other embodiments however, different viewing panels 22 of an exhibition case 20 may have panel mounts 46 located at different respective locations.

Referring to FIG. 2A the exhibition case 20 is shown in an embodiment wherein each of the viewing panels 22 are in the closed configuration. The embodied exhibition case 20 comprises covering bands 70. There is one covering band 70 for the two upper frame sections 28 and one covering band for the two bottom frame sections 28. Referring now to FIG. 4, the covering band 70 may be detachably secured to or pivotally mounted to the frame 24 and may cover the height of the frame 24, the panel guide member 54, the panel mount 46 and the soft locking mechanism 26 when the panel guide member 54 is in the closed configuration. There may be more or less than one covering band 70 per upper or lower section 28 of the frame 24. The covering band 70 may thus act as a visual barrier to hide the mechanisms of the exhibition case 20 from the viewing eyes of people. The covering band 70 may also act as a physical barrier by physically covering various parts of the exhibition case 20. The covering band 70 may therefore prevent entry and accumulation of particles which may damage or dirty the exhibition case 20. Understandably, the covering band 70 may block the transversal displacement of the panel guide member 54. Thus, it may be removed prior to transversal displacement of the panel guide member 54. The covering band 70 may alternatively be displaced or pivoted (for instance about an axis parallel to the longitudinal axis of the frame) away from covering the exhibition case 20 without being detached or uninstalled from the same.

In the non-limitative embodiment shown, the covering bands 70 are mounted to the upper and lower (bottom) frame sections 28. However, it is appreciated that, in an alternative embodiment (not shown), covering bands 70 can also be mounted to the vertically-extending frame sections, i.e. the frame sections extending between the upper and lower (bottom) frame sections 28.

Referring now to FIG. 2B, the exhibition case 20 is shown in an embodiment wherein one of the viewing panels 22 is in the closed configuration and wherein another viewing panel 22 is in the open configuration. The covering band 70 has been removed from the previous embodiment to allow forward displacement of the panel guide members 54 as shown in FIG. 6.

Referring to FIGS. 4 and 6, the panel guide members 54 and the panel mounts 46 in the upper frame section 28 are different from the panel guide members 54 and panel mounts 46 in the lower frame section 28. More specifically, the lower frame section 28 comprises the embodiment of the panel guide member 54 and panel mount 46 shown in FIGS. 7 and 9 whereas the upper frame section 28 comprise the embodiment of the panel guide member 54 and panel mount 46 shown in FIGS. 8 and 10. In other embodiments that are not shown, any combination of the above-described panel guide members 54 and panel mounts 46 may be used in the upper and lower frame sections 28. For example, the panel guide member 54 and panel mount 46 of FIGS. 7 and 9 may be used in the upper and lower frame sections 28.

In the embodiment of FIG. 4, the upper and lower panel mounts 46 are in the closed configuration. Accordingly, the panel mounts 46 are received in their respective nook 42 and may therefore not be displaced longitudinally since the rollers 52 and/or the panel mounts 46 may abut against the body of the frame 24. The viewing panels 22 are thus effectively blocked from movement along the longitudinal axis 30.

In the embodiment of FIG. 6, the upper and lower panel mounts 46 are in the open configuration. The panel mounts 46 are therefore in-line with their respective rail 34 and may be further displaced and guided in the longitudinal axis 30 in front of another viewing panel 22 of the exhibition case 20 and over the rail 34 and front rail-shaped segments 62 of another frame section 28 of the exhibition case 20.

In the embodiments shown in FIGS. 4 and 6, the bottom panel mount 46 may support the weight of the viewing panel 22. Although the top panel mount 46 may also support the viewing panel 22, it may alternatively simply guide said panel without providing substantial weight support. The fit of the panel mounts 46 to the shape of the viewing panel 22 and additional fastening means may therefore be considered to provide more or less weight support from each of the lower or upper panel mounts 46.

Still in the illustrated embodiments of FIGS. 4 and 6, the frame comprises rollers 72 located under the bottom panel guide member 54 to allow or at least ease transversal displacement of the same. It may be understood that any other means to facilitate transversal displacement of the panel guide member 54 with respect to the frame 24 may be used, such as fluids with low friction coefficients, magnets, and so on.

In the embodiments shown, as presented in FIGS. 4 and 6, the exhibition case 20 further comprises a sealing band 74. The sealing band 74 may be positioned on a bracket 76 to provide height to the first. The sealing band 74 is located next to the panel guide member 54 when in the closed configuration and opposite to the covering band 70 relative to the viewing panel 22, such that when the panel mount 46 and associated viewing panel 22 is in the closed configuration, it abuts against the sealing band 74. The abutment of the sealing band 74 and of the viewing panel 22 may therefore create a seal that may prevent or at least reduce the risks of particles entering or leaving the exhibition case 20. The sealing band 74 may be made of any material known in the art having good sealing characteristics and flexibility, such as but not limited to felt, fibers, silicone, and other suitable elastomers in their pure, composite, and hybrid forms.

As mentioned above, the viewing panel displacement assembly of the exhibition case 20 includes the soft locking mechanism 26. In some implementation, the soft locking mechanism 26 is configured for soft locking the panel mount 46 in either one of the closed configuration or in the open configuration. The term “soft locking” is used to refer to a locking mechanism that is temporarily locked when the mechanism arrives at a given position and that may be unlocked with an exterior force applied to the mechanism, such as a push and/or pull from a user. The force required to unlock the mechanism may vary, however it may be low enough for a user to unlock the mechanism with normal expected effort for such a task.

Referring now to FIGS. 11 to 22, two embodiments of soft locking mechanisms 26 of the viewing panel displacement assembly 23 are shown, by way of example.

Referring specifically to FIGS. 11 to 16, a first embodiment of the soft locking mechanism 26 is shown. FIGS. 11, 12 and 15 show the soft locking mechanism 26 in the closed configuration whereas FIGS. 13, 14 and 16 show the soft locking mechanism 26 in the open configuration.

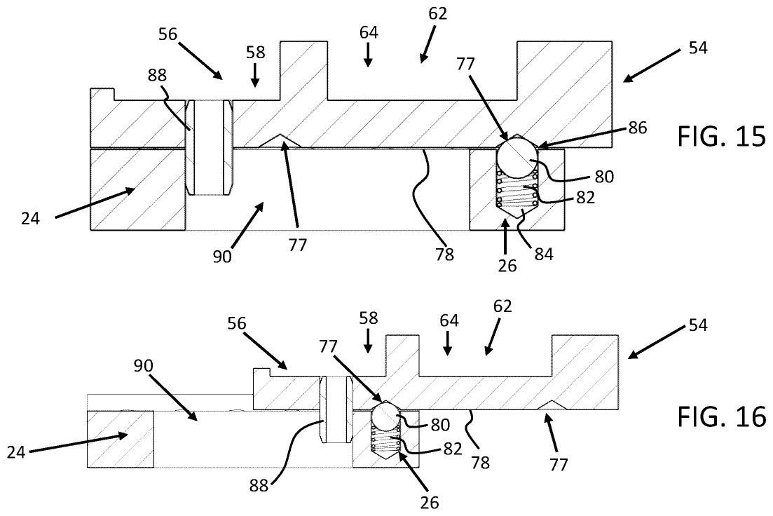

Referring now to FIGS. 15 and 16, shown is a cross-sectional view of the soft locking mechanism 26 according to a first embodiment. In this embodiment, the panel guide member 54 includes two depressions 77 in its outer surface 78. A ball 80 and spring 82 (or biasing member) assembly is at least partly housed in a recess 84 extending in the frame 24, with the recess 84 including an opening 86 on an inner surface of the frame 24. With the vertical force from the spring 82, the ball 80 may be raised outwardly from the recess 84 and at least partially over the opening 86 of the recess 84. The ball 80 may abut against the outer surface 78 of the panel guide member 54 and, when the panel guide member 54 is displaced at specific locations, the ball 80 may engage with any one of the depressions 77 defined in the outer surface 78 of the panel guide member 54 and thereby limit its transversal displacement. The partial entry of the ball 80 inside one of the depressions 77 will secure the panel mount 46, and thus of the viewing panel 22. The panel guide member 54 may therefore be soft locked in place until exterior forces are applied to the viewing panel 22 or the panel mount 46 by a user.

The position of the depressions 77 may correspond to the closed and open configurations of the viewing panel 22 and panel mount 46. The soft locking mechanism 26 may therefore soft lock the viewing panel 22 and panel mount 46 in place when in the corresponding one of the closed and open configurations. Unless sufficient transversal exterior force is applied to the locked viewing panel 22 or panel mount 46, the soft locking mechanism 26 will remain locked. In other embodiments, there may be more or less depressions 77 and balls 80 and springs 82. It is appreciated that, in an alternative embodiment, the spring 82 can be replaced by another suitable biasing member. Similarly, it is appreciated that, in an alternative embodiment, the ball 80 can be replaced by another abutting member engageable in each one of the depressions 77. It is appreciated that the shape of the abutting member 80, the biasing member 82, the recess 84, and the depression 77 can vary from the embodiment shown.

In the embodiment shown, the soft locking mechanism 26 may further comprise a stopper 88. The stopper 88, while not soft locking the viewing panel 22 and panel mount 46 in place, may prevent the same from exceeding transversal displacement past at least one of the closed and open configurations. The stopper 88 may be an elongated piece protruding downwardly from the panel guide member 54 in an open space or transversal slit 90 defined in the frame 24. Accordingly, when displaced laterally, the stopper 88 may abut against the body of the frame 24 when arriving at lateral ends of the open space or slit 90 and may thus prevent further transversal displacement of the panel guide member 54 past the closed and open configurations.

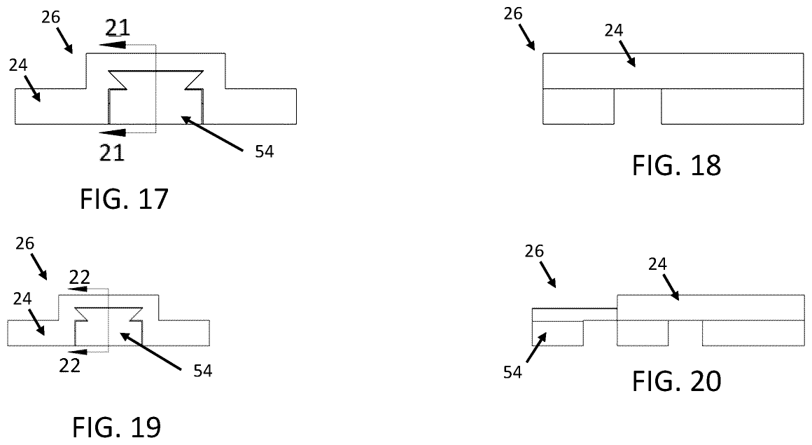

Referring now specifically to FIGS. 17 to 22, a second embodiment of the soft locking mechanism 26 is shown. FIGS. 17, 18 and 21 show the soft locking mechanism 26 in the closed configuration whereas FIGS. 19, 20 and 22 show the soft locking mechanism 26 in the open configuration.

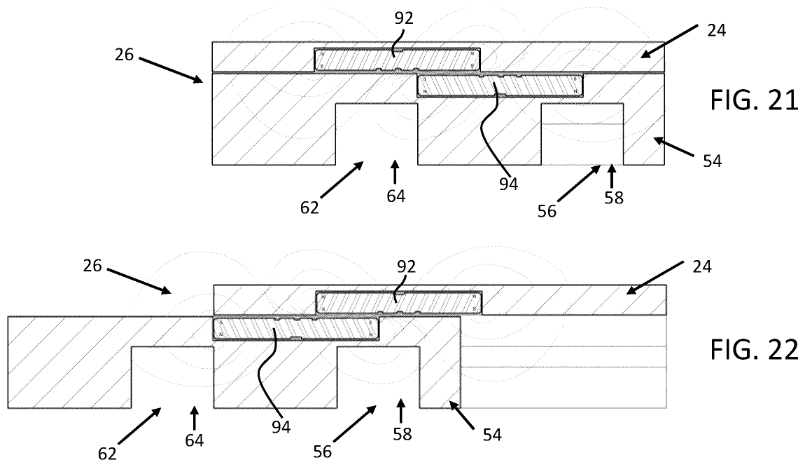

Referring now to FIGS. 21 and 22, the embodiment shown is a cross-sectional view of the soft locking mechanism 26 according to second embodiment. In this variant, the soft locking mechanism 26 includes magnets 92, 94 to soft lock the panel guide member 54 in either the closed or the open configuration. A first magnet 92 is partly or fully housed in the frame 24 and a second magnet 94 is partly or fully housed in the panel guide member 54. The two magnets 92, 94 are adjacent to one another and may enter in contact when superposed over one another. Because the magnets 92, 94 repel one another, they constantly apply forces pushing each one away from the other. When the panel guide member 54 is in the closed configuration, its magnet 94 is arranged so that it is laterally offset from the magnet 92, towards the rear of the frame 24. Hence, in the closed configuration, the panel guide member 54 can receive a constant force towards the rear. When the panel guide member 54 is in the open configuration, its magnet 94 is arranged so that it is laterally offset from the magnet 92, towards the front of the frame 24. Accordingly, in the open configuration, the panel guide member 54 can receive a constant force towards the front.

It may be appreciated that the second embodiment of the soft locking mechanism 26 may displace, due to the forces applied by the magnets 92, 94 the panel guide member 54 towards the closed or open configuration the moment the magnets 92, 94 are slightly offset from one another. As such, the embodied soft locking mechanism 26 may only allow for the panel guide member 54 to be positioned in the closed or open configuration without any possible intermediate configuration.

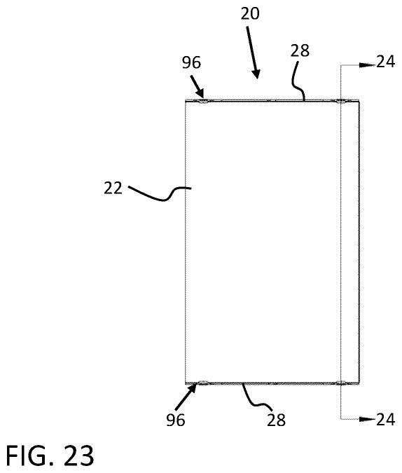

Referring now to FIGS. 23 to 26, the shown portion of exhibition case 20 further includes hard locking mechanisms 96. In the embodiment shown, the portion of exhibition case 20 includes two hard locking mechanisms 96, one mounted to the upper portion of the frame 24 and one mounted to the lower portion of the frame 24. However, it is appreciated that, in alternative embodiments, the portion or the exhibition case 20 can include only one hard locking mechanism 96, mounted either to the upper or the lower portions of the frame 24. The portion or the exhibition case 20 can also be free of hard locking mechanism 96.

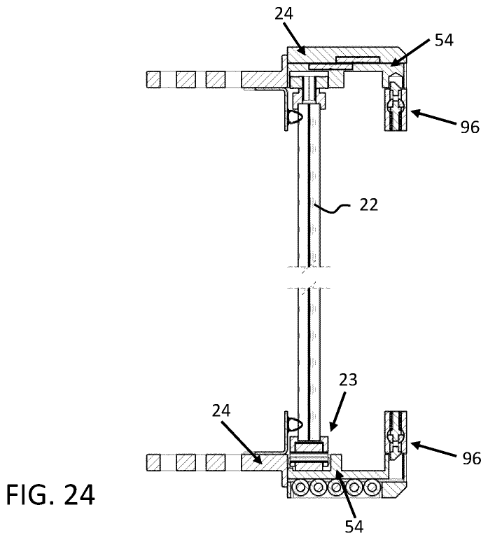

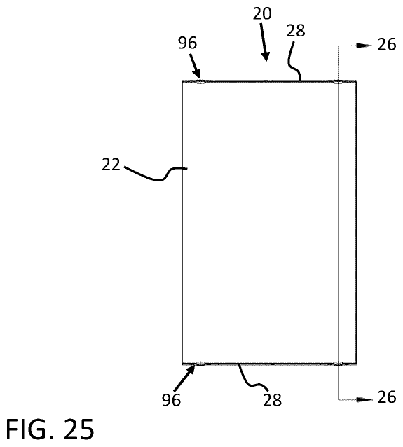

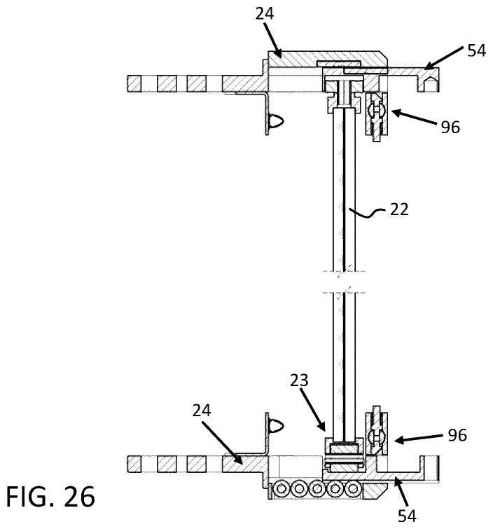

Each one of the hard locking mechanisms 96 is selectively configurable in a locked configuration or in an unlocked configuration. In an embodiment, the hard locking mechanism 96 is configurable in the locked configuration when the panel guide member is in the closed configuration. More particularly, in the locked configuration shown in FIGS. 23 and 24, the hard locking mechanism 96 prevents the panel guide member 54 from leaving the closed configuration, i.e., it ensures that the panel guide member 54 remains in the closed configuration. In the unlocked configuration shown in FIGS. 25 and 26, the hard locking mechanism 96 does not prevent the panel guide member 54 from moving between the closed and open configurations. Thus, if a change of configuration of the panel guide member 54 is required, the hard locking mechanism must be configured in the unlocked configuration to allow the panel guide member 54 to change configuration. In the non-limitative embodiment shown, the hard locking mechanism 96 is mounted to the frame 24, inwardly and substantially adjacent to the panel guide member 54. Understandably, should the exhibition case 20 include a plurality of the panel guide members 54, it can include an equivalent number of the hard locking mechanisms 96. In other embodiments, there may be the same number or more of the panel guide members 54 than the hard locking mechanisms 96.

As it will be described in more details below, in some embodiments, the hard locking mechanism 96 can also be configurable in the locked configuration when the panel guide member is in the open configuration in a manner such that it ensures that the panel guide member 54 remains in the open configuration.

Since the hard locking mechanisms 96 mounted to the upper and the lower portions of the frame 24 can be similar, only the hard locking mechanism 96 mounted to the lower portion of the frame 24 will be described in the following paragraphs. However, it is appreciated that the description also applies to the hard locking mechanisms 96 mounted to the upper portion of the frame 24.

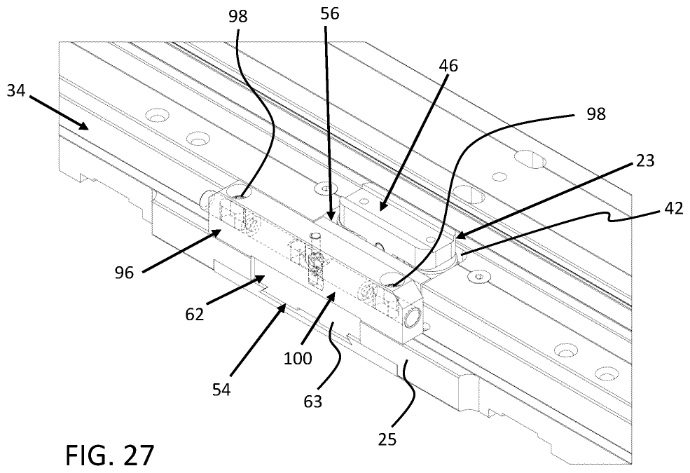

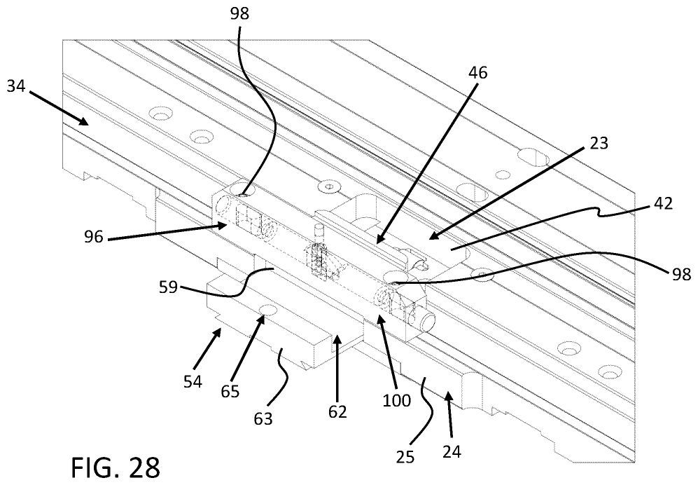

Referring now to FIGS. 27 and 28, a non-limitative embodiment of the viewing panel displacement assembly 23 is shown in the closed and open configurations respectively. In FIG. 27, the viewing panel displacement assembly 23 is shown in the closed configuration, such that the panel mount 46 and the rear rail-shaped segment 56 are received in the nook 42, and the front rail-shaped segment 62 is aligned with the rail 34 of the frame 24. In FIG. 28, the viewing panel displacement assembly 23 is shown in the open configuration, such that the panel mount 46 and the rear rail-shaped segment 56 are aligned with the rail 34, and the front rail-shaped segment 62 projects in front of the frame 24.

In the non-limitative embodiment shown, the hard locking mechanism 96 is secured to the frame 24, at least partially over the panel guide member 54, without being mounted thereto, and more specifically over a forward wall 63 of the front rail-shaped segment 62 when the viewing panel displacement assembly 23 is in the closed configuration. The hard locking mechanism 96 may be secured to the frame 24 by way of mechanical fasteners 98, such as screws, or by any others fastening means.

Being secured to the frame 24 over the panel guide member 54 without being mounted thereto, it can be appreciated that when the hard locking mechanism 96 is in the unlocked configuration, the panel guide member 54 can therefore be translated independently from the hard locking mechanism 96 which remains at a fixed position mounted to the frame 24.

In the non-limitative embodiment shown, the hard locking mechanism 96 includes a body 100 configured to receive internal components of the mechanism 96. The illustrated body 100 has a substantially elongated rectangular profile. When secured to the frame 24, the body can have a width that is substantially equal to, wider, or narrower than a width of the forward wall 63 of the front rail-shaped segment 62 or of a width of a forward frame wall 25. The body 100 mounted to the frame 24 does not impede translation movements of the panel mount 46 or of the viewing panel 22 being displaced along the rail 34.

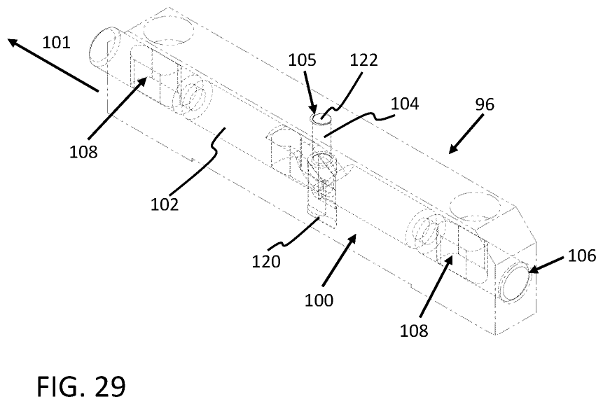

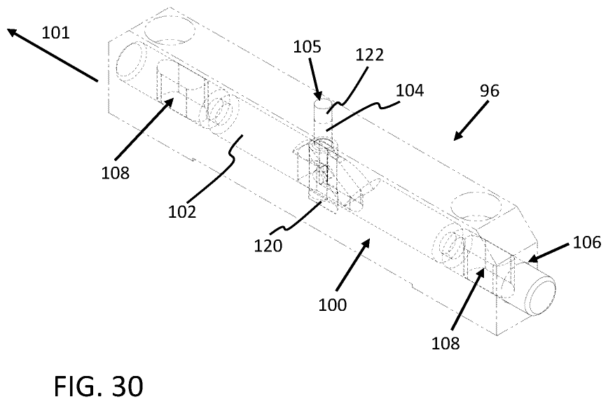

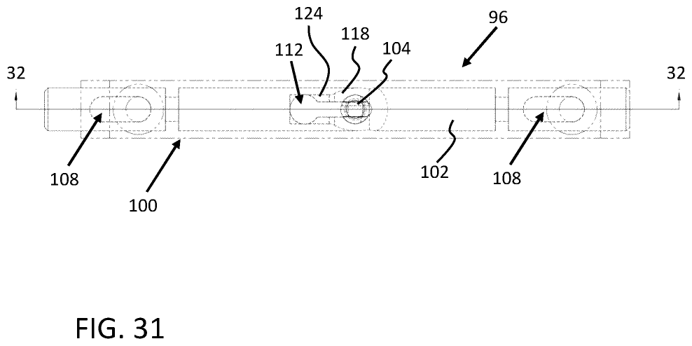

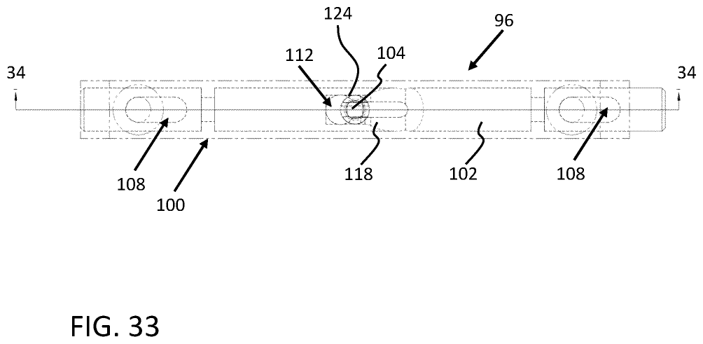

Referring now to FIGS. 29 to 34, in the non-limitative embodiment shown, the hard locking mechanism 96 further includes a locking beam 102 and a locking pin 104, at least partially contained in the body 100. Each one of the locking beam 102 and the locking pin 104 can be displaced between a locked configuration and an unlocked configuration, corresponding to the locked configuration and the unlocked configuration respectively of the hard locking mechanism 96. The locking beam 102 is received in an elongated channel 106 that extends substantially parallel to a longitudinal axis 101 of the body 100 and parallel to the rail 34, from one side to another opposite side of the body 100. In the embodiment shown, the locking beam 102 is longer than the body 100 such that at least a portion of the locking beam 102 projects outside of the body 100, when inserted therein. In the locked configuration shown in FIGS. 29, 31 and 32, the locking beam 102 has a first end that projects from one side of the body 100, and in the unlocked configuration shown in FIGS. 30, 33 and 34, the locking beam 102 has a second end, opposed to the first end, that projects from the opposite side of the body 100. When projecting outside of the body 100, the first and the second ends of the locking beam 102 are accessible. In the non-limitative embodiment shown, the locking beam 102 includes elongated slits 108 extending therethrough and aligned with fastener holes defined in the body 100, when slidably inserted in the elongated channel 106. Therefore, the mechanical fasteners 98 used to secure the hard locking mechanism 96 to the frame 24 can be inserted in the fastener holes and extend through the elongated slits 108, without impeding the translation of the locking beam 102 inside the elongated channel 106. The slits 108 can also limit and prevent the displacement of the locking beam 102 past the locked and unlocked configurations by abutting against the mechanical fasteners 98.

The locking pin 104 extends in an elongated channel 105 defined in the body 100 of the hard locking mechanism 96, normal to the elongated channel 106 containing the locking beam 102. The elongated channel 105 and the locking pin 104 extending at least partially therein extend substantially vertically from an exposed surface of the body 100 and towards the frame 24. The elongated channel 105 is open on both surfaces of the body 100. The locking pin 104 can be longer than a height of the body 100, such that a portion of the locking pin 104 can always project outwardly from the body 100, either towards the frame 24 or inwardly of the exhibition case 20. In the embodiment shown, the hard locking mechanism 96 can also include a biasing member 110 biasing the locking pin 104 to the locked configuration. The biasing member 110 can be a spring positioned between the body 100 and the locking pin 104. In the configuration shown in FIGS. 29, 31 and 32, the locking pin 104 is configured in a pin locked configuration and projects outwardly of the body 100 of the hard locking mechanism 96 and towards the frame 24. When the locking pin 104 is configured in the pin locked configuration, the hard locking mechanism 96 is configured in the locked configuration. In the pin locked configuration, an engagement portion 120 of the locking pin 104 extends outwardly of the body 100, preventing displacement of the panel guide member 54. The engagement portion 120 of the locking pin 104 can therefore abut against or enter in contact with the panel guide member 54, e.g., it can abut against the forward wall 63 of the front rail-shaped segment 62. In the configuration as shown in FIGS. 30, 33 and 34, the locking pin 104 is configured in a pin unlocked configuration and is retracted within the body 100 of the hard locking mechanism 96, and a second portion 122 of the locking pin 104, opposed to the engagement portion 120, can project outwardly from the body 100 and inwardly of the exhibition case 20. When the locking pin 104 is configured in the pin unlocked configuration, the hard locking mechanism 96 is configured in the unlocked configuration.

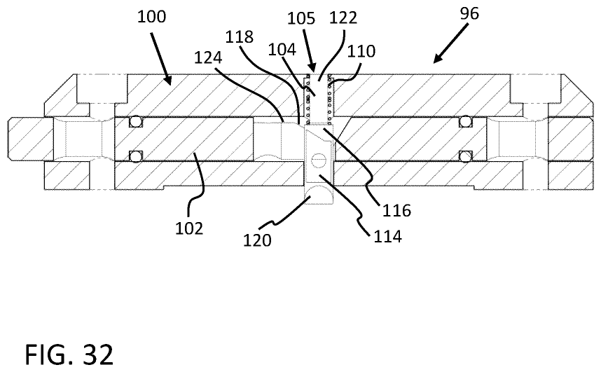

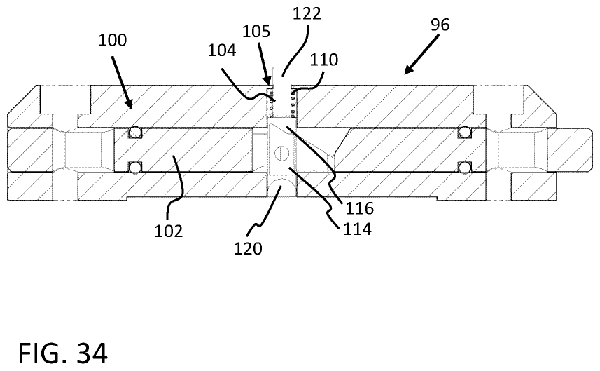

In the embodiment shown, referring to FIGS. 32 and 34, the locking pin 104 is dividable into two sections along its length: a first section 114 including the engagement portion 120 and a second section 116 including the second portion 122. In the embodiment shown, the second section 116 has, in average, a greater diameter than the first section 114. Therefore, a shoulder is defined between the two sections 114, 116. The purpose will be described in more details in the paragraphs below.

The locking beam 102 includes a pin receiving slotted hole 112, through which a section of the locking pin 104 extends. A length of the pin receiving slotted hole 112 is longer than a diameter of the locking pin 104. Upon translation of the locking beam 102 inside the elongated channel 106, the locking pin 104 translates within the pin receiving slotted hole 112. The first section 114 of the locking pin 104, characterized by a smaller diameter than a diameter of the second section 116, is insertable into the pin receiving slotted hole 112, while the second section 116 is characterized by a diameter too large to be insertable into the pin receiving slotted hole 112.

In the non-limitative embodiment shown, in periphery to the pin receiving slotted hole 112, the locking beam 102 includes a beveled surface 118 against which the shoulder of the locking pin 104 abuts. Therefore, the locking pin 104 can be translated within the pin receiving slotted hole 112 by sliding against the beveled surface 118 of the locking beam 102. Thus, upon translation of the locking pin 104 inside the pin receiving slotted hole 112, the hard locking mechanism 96 is selectively configurable between the unlocked configuration (FIG. 34) with the engagement portion 120 of the locking pin 104 being recessed inside the pin receiving slotted hole 112 and the locked configuration (FIG. 32) with the engagement portion 120 of the locking pin 104 protruding outwardly of the body 100 and engageable with the panel guide member 54. As mentioned above, the biasing member 110 biases the locking pin 104 into the locked configuration. Therefore, by translating the locking beam 102 within the elongated channel 106, the locking pin 104 can be selectively configured in the unlocked configuration. If the locking beam 102 is released, the biasing member 110 can automatically reconfigure the locking pin 104 into the locked configuration, the locking beam 102 translating simultaneously within the elongated channel 106.

Still in the non-limitative embodiment shown, in the periphery of the pin receiving slotted hole 112, the locking beam 102 further includes a flat surface 124. The flat surface 124 is adjacent the beveled surface 118 and is positioned at an end of the pin receiving slotted hole 112 that receives the locking pin 104 when the hard locking mechanism 96 is in the locked configuration. The flat surface 124 is oriented substantially normal to the force applied by the biasing member 110 on the locking pin 104. In the unlocked configuration, the shoulder of the locking pin 104 therefore rests on the flat surface 124 such that reconfiguration of the locking pin 104 into the locked configuration by the biasing member 110 is prevented. Once the shoulder of the locking pin 104 is displaced past the flat surface 124, on the beveled surface 118 of the locking beam 102, then the biasing member 110 can displace the locking pin 104 towards the locked configuration.

In the embodiment shown, referring to FIG. 28, the hard locking mechanism 96 further includes a locking hole 65 defined in the forward wall 63 of the front rail-shaped segment 62. Thus, in the closed configuration of the viewing panel displacement assembly 23 and in the locked configuration of the hard locking mechanism 96, the engagement portion 120 of the locking pin 104 can be inserted in the locking hole 65. To configure the viewing panel displacement assembly 23 in the open configuration, the hard locking mechanism 96 is first configured in the unlocked configuration by translating the locking beam 102 within the elongated channel 106, thereby simultaneously translating the locking pin 104 within the elongated channel 105 and disengaging the engagement portion 120 from the locking hole 65. Once the hard locking mechanism 96 is configured in the unlocked configuration, the viewing panel displacement assembly 23 can be configured in the open configuration. Thus, in the locked configuration of the hard locking mechanism 96, the locking pin 104 prevents the panel guide member 54, configured in the closed configuration, to be displaced.

In the non-limitative embodiment shown, in the locked configuration of the hard locking mechanism 96, the engagement portion 120 of the locking pin 104 is inserted in the locking hole 65. However, it is appreciated that, in an alternative embodiment (not shown), the locking pin 104 can abut against a vertical surface of the forward wall 63.

In the paragraphs above and the attached figures, the hard locking mechanism 96 is shown in the locked configuration that corresponds to the closed configuration of the viewing panel displacement assembly 23. However, it is appreciated that it can also be configured in the locked configuration when the viewing panel displacement assembly 23 is configured in the open configuration. In such embodiment, the locking pin 104 can engaged a front wall 59 (FIG. 28) of the rear rail-shaped segment 56 or a locking hole (not shown) defined in the front wall 59 of the rear rail-shaped segment 56.

It is appreciated that the shape, the components and the configuration of the hard locking mechanism 96 can vary from the embodiment shown. Amongst others, the actuator of the hard locking mechanism 96 can differ from the locking beam 102 shown in the figures.

In some implementations, the panel mount 46, the panel guide member 54, the soft locking mechanism 26, and the hard locking mechanism 96 may comprise a viewing panel displacement assembly 23 which may be provided separately for installation of a new exhibition case 22 or repair of an existing one. Multiple viewing panel displacement members 23 may be provided as part of a kit.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. An exhibition case, comprising:
a viewing panel;
a frame defining:
a longitudinal axis and a transversal axis,
a rail for receiving and displacing at least a portion of the viewing panel along the longitudinal axis, and
a nook laterally positioned to the rail;
a panel mount engaging the viewing panel; and
a panel guide member having a mount-receiving portion, the panel guide member being displaceable along the transversal axis of the frame between a closed configuration wherein the panel mount is housed in the nook and an open configuration wherein the panel mount is in-line with the rail; and
a soft locking mechanism configured for soft locking the panel mount in either one of the closed configuration or the open configuration.

2. The exhibition case of claim 1, wherein the panel mount comprises one or more of: one or more rollers pivoting about the longitudinal axis, one or more rollers pivoting about the transversal axis, and one or more rollers pivoting about a vertical axis.

3. The exhibition case of claim 1, wherein the panel guide member comprises a rear rail-shaped segment defining the mount-receiving portion and a front rail-shaped segment, the front rail-shaped segment being in-line with the rail when the panel guide member is in the closed configuration.

4. The exhibition case of claim 3, comprising an additional viewing panel and an additional panel mount engaging the additional viewing panel, wherein the additional panel mount is displaceable in the front rail-shaped segment when the panel guide member is in the closed configuration.

5. The exhibition case of claim 1, wherein the panel guide member is slideably secured to the frame in a dovetail configuration.

6. The exhibition case of claim 1, wherein the panel guide member comprises one or more depressions and the soft locking mechanism comprises a biasing member at least partly housed in the frame and configured to engage with the one or more depressions.

7. The exhibition case of claim 6, wherein the biasing member comprises a ball and spring assembly engageable with one of the one or more depressions in the open configuration and with another of the one or more depressions in the closed configuration.

8. The exhibition case of claim 1, wherein the soft locking mechanism comprises a magnetic mechanism that comprises a first magnet at least partially contained in the frame and a second magnet at least partially contained in the panel guide member.

9. The exhibition case of claim 1, further comprising a covering band covering a combined height of the frame, the panel guide member, the panel mount and the soft locking mechanism when the panel guide member is in the closed configuration.

10. The exhibition case of claim 1, wherein the panel guide member further comprises a stopper configured to abut against the frame when past the open configuration or the closed configuration along the transversal axis.

11. The exhibition case of claim 1, wherein the frame comprises a bracket mounted to or formed integral with the frame, and a sealing band mounted to the bracket and configured to abut against the panel guide member in the closed configuration.

12. The exhibition case of claim 1, wherein the frame comprises rolling means for displacing the panel guide member along the transversal axis between the closed and open configurations.

13. The exhibition case of claim 1, further comprising:
a hard locking mechanism mounted to the frame and selectively configurable in a locked configuration to prevent displacement of the panel guide member when the panel guide member is configured in the closed configuration and in an unlocked configuration wherein displacement of the panel guide member is allowed.

14. The exhibition case of claim 13, wherein the hard locking mechanism comprises:
a body secured to the frame; and
a locking pin slideably mounted to the body and translatable between a pin locked configuration
wherein an engagement portion of the locking pin extends outwardly of the body preventing
displacement of the panel guide member and the unlocked configuration wherein the
displacement of the panel guide member is allowed.

15. An exhibition case, comprising:
a viewing panel;
a frame defining a longitudinal axis and a transversal axis and comprising a top frame section
and a bottom frame section, each of the top and bottom frame sections defining:
a rail for receiving and displacing at least a portion of the viewing panel along the longitudinal axis, and
a nook laterally positioned to the rail;
upper and lower panel mounts engaging the viewing panel; and
upper and lower panel guide members each having a mount-receiving portion, the upper and lower panel guide members being displaceable along the transversal axis of the frame between a closed configuration wherein each one of the upper and lower panel mounts is housed in the corresponding nook and an open configuration wherein each one of the upper and lower panel mounts is in-line with the rail; and
upper and lower soft locking mechanisms configured for soft locking the corresponding one of the upper and lower panel mounts in either one of the closed configuration or the open configuration.

16. The exhibition case of claim 15, wherein at least one of the upper and lower panel guide members comprises one or more depressions and the corresponding one of the upper and lower soft locking mechanisms comprises a biasing member at least partly housed in the corresponding one of the top and bottom frame sections and configured to engage with the one or more depressions.

17. The exhibition case of claim 15, wherein at least one of the upper and lower soft locking mechanisms comprises a first magnet at least partially contained in the corresponding one of the top and bottom frame sections and a second magnet at least partially contained in the corresponding one of the upper and lower panel guide members.

18. A viewing panel displacement assembly for an exhibition case comprising a viewing panel and a frame defining a longitudinal axis and a transversal axis, the frame comprising a rail for receiving and displacing at least a portion of the viewing panel along the longitudinal axis, and a nook laterally positioned to the rail, the viewing panel displacement assembly comprising:
a panel mount engageable with the viewing panel and a panel guide member having a mount-receiving portion, wherein, when in use, the panel guide member is displaceable along the transversal axis between a closed configuration wherein the panel mount is housed in the nook and an open configuration wherein the panel mount is in-line with the rail; and
a soft locking mechanism configured for soft locking the panel mount in either one of the closed configuration or the open configuration.

19. An exhibition case, comprising:
a viewing panel;
a frame defining:
a longitudinal axis and a transversal axis,
a rail for displacing the viewing panel along the longitudinal axis, and
a nook laterally positioned to the rail;
a panel mount engaging the viewing panel; and
a panel guide member having an inner surface and an outer surface, opposed to the inner surface,
the panel guide member comprising a rear rail-shaped segment defining a mount-receiving portion and a front rail-shaped segment from the inner surface thereof, the panel guide member being displaceable along the transversal axis of the frame between:
a closed configuration wherein the rear rail-shaped segment is housed in the nook and the front rail-shaped segment is in-line with the rail; and
an open configuration wherein the rear rail-shaped segment is in-line with the rail and the front rail-shaped segment projects from the frame unsupported.

20. The exhibition case of claim 19, further comprising an additional viewing panel and an additional panel mount engaging the additional viewing panel, wherein the additional panel mount is displaceable in the front rail-shaped segment when the panel guide member is in the closed configuration.
